(19) United States
(12) Patent Application Publication
(10) Pub. No.: US 2006/0077175 A1
(43) Pub. Date: Apr. 13, 2006

(54) Machine-human interface

(76) Inventor: Maurizio Pilu, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/243,841

(22) Filed: Oct. 5, 2005

(30) Foreign Application Priority Data
Oct. 7, 2004 (GB) 0422233.7

(51) Int. Cl. G09G 5/00

(52) U.S. Cl. 345/156

(57) ABSTRACT

One embodiment of a machine-human interface apparatus comprises a first device adapted to be substantially fixedly mounted relative to a portion of a first hand of a user, and a second device adapted to be substantially fixedly mounted relative to a portion of a digit of the other hand of the user, at least one of the devices comprising a transducer operable to generate a signal representative of the relative position or movement of the devices.

### CLAIM TO PRIORITY

This application claims priority to copending United Kingdom utility application entitled, “Machine-Human Interface,” having serial no. GB 0422233.7, filed Oct. 7, 2004, which is entirely incorporated herein by reference.

### TECHNICAL FIELD

The present disclosure relates to the field of input devices.

### BACKGROUND

Various interfacing methods are known. For example, the computer keyboard provides a well known interface for inputting data and controlling a computer. The use of keyboards has also extended into the mobile computing field with relatively small and compact keyboards available for use with personal digital assistants (PDAs) and the like.

Other input devices are known including conventional devices such as mice, and track-balls, to less commonly used input devices such as styli which are capable of being used in conjunction with ‘digital paper’, and ‘virtual keyboards’ such as that provided by Canesta, Inc. (at web site located at network address www.canesta.com). Other interface devices comprising cameras operable to detect a position of a pointer or finger from a user perspective are also known such as the “Finger Mouse.”

There are disadvantages associated with the above-mentioned interfaces. For example, computer keyboards require a large amount of desktop space. Also, such devices are generally unsuitable for use with mobile devices such as mobile telephones, PDAs and the like since a user will often be using the device in areas or circumstances where suitable surfaces for resting a keyboard or other sensing device such as a digital pad or paper are not available.

Similar disadvantages exist with the use of mice, track-balls, or styli. In particular, the use of styli is effective only where a suitably adapted surface is used which has sensing capabilities (passive stylus for example), or where the stylus itself includes sensing functionality operable to determine a position/orientation/movement of the stylus.

In order to overcome the above problems, devices have been proposed which obviate the need for desk space or sensing areas such as “air mice” for example which interface with a computer simply by waving the device around in air. Such devices are unable to provide a user with important tactile feedback however, which can cause problems with use, and are relatively large and cumbersome.

### SUMMARY

According to a first aspect of the present disclosure, there is provided machine-human interface apparatus comprising a first device adapted to be substantially fixedly mounted relative to a portion of a first hand of a user, and a second device adapted to be substantially fixedly mounted relative to a portion of a digit of the other hand of the user, at least one of the devices comprising a transducer operable to generate a signal representative of the relative position or movement of the devices.

According to a second aspect of the present disclosure, there is provided apparatus for inputting data to a remote device comprising first and second wirelessly coupled input devices, the first device adapted to be substantially fixedly supported relative to a first hand of a user, the second device adapted to be substantially fixedly supported relative to a portion of a digit of the other hand of a user, wherein at least one of the devices comprises a sensor operable to generate a signal representing a relative position of the devices.

According to a third aspect of the present disclosure there, is provided a method of inputting data to a remote device using two input devices, each device substantially fixedly supported relative to a portion of a respective hand of a user, the method comprising generating movement data in at least one of the devices representing a position or movement of one device with respect to the other device, comparing the generated movement data with stored data representative of relative movements of the devices, the stored data corresponding to respective characters to be input to the remote device, or of respective functions for controlling the remote device, inputting data to the remote device on the basis of the comparison of the generated data to the stored data.

### BRIEF DESCRIPTION OF THE DRAWINGS

For a better understanding of the present disclosure, and to further highlight the ways in which it may be brought into effect, various embodiments will now be described, by way of example only, with reference to the following drawings in which:

FIG. 1 is a schematic representation of an input device suitable for use in an embodiment;

FIG. 2 is a schematic representation of an input device suitable for use, in an embodiment, in conjunction with the device of FIG. 1;

FIG. 3 is a schematic representation of the arrangement of the wireless devices of FIGS. 1 and 2 according to one model;

FIG. 4 is a schematic block diagram of a suitable architecture for the device of FIG. 2 according to an embodiment; and

FIG. 5 is a schematic block diagram of a suitable architecture for the device of FIG. 1 according to an embodiment.

It should be emphasized that the term “comprises/comprising” when used in this specification specifies the presence of stated features, integers, steps or components but does not preclude the presence or addition of one or more other features, integers, steps, components or groups thereof.

### DETAILED DESCRIPTION

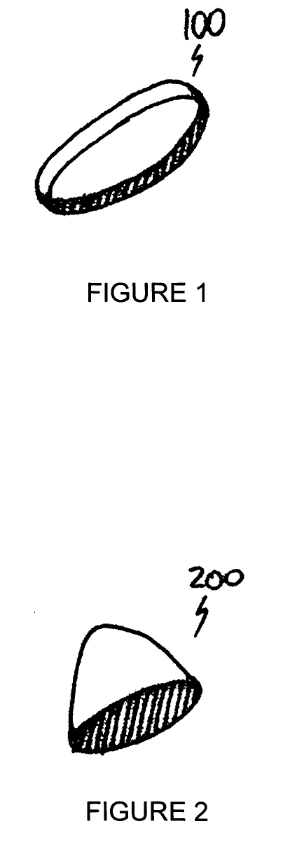

FIG. 1 of the accompanying drawings is a schematic representation of a device 100 suitable for use in an embodiment. In one embodiment, the device 100 is suitable for being substantially fixedly mounted relative to a portion of a hand of a user (not shown), and can be in the form of a ring for example. Alternative forms of the device 100 are possible. For example, it may be in the form of a pad, or any other suitable form which is adapted to stick or be otherwise mounted, attached or supported relative to a portion of a user's hand.

Substantially fixedly mounting or supporting the device can be characterized as the provision of securely, but releasably, arranging the device in a desired position with respect to some arbitrary frame of reference such as a hand, arm of torso of a person for example.

In one embodiment, the device 100 is worn by a user on the proximal phalanx of one of their digits, and is adapted to wirelessly transmit and receive data using, for example, Bluetooth or any other suitable radio-frequency communications protocol such as ZigBee for example; infrared or fast infra-red; or other suitable communications means such as in-audible (to humans) sound such as ultrasound for example, or other invisible (to humans) light.

The device 100 is operable to establish a communications channel using any one of the above-mentioned means to a remote device (not shown). The remote device can be a personal computer, a PDA or mobile telephone for example, or a further device similar to 100 suitable for being supported by or otherwise mounted on a user. In certain embodiments, it is envisaged that the device 100 will only be operable to transmit data to a remote device using the communications channel.

FIG. 2 is a schematic representation of a device 200 suitable for use in an embodiment. The device 200 is suitable for being substantially fixedly mounted relative to a portion of the hand of a user, and in one embodiment is in the form of a cap suitable for being supported or otherwise mounted on the tip of a digit of a hand of a user (not shown). Alternative forms of the device 200 are possible. For example, it may be in the form of a ring similar to that described above, but such that it is adjusted to fit on the tip of a digit of a hand for example, or a pad which is adapted to stick to or otherwise be supported by or mounted on a portion of a user's hand.

In one embodiment, the device 200 is substantially fixedly mounted on or supported by a portion of a digit of a hand of a user, exemplary on the distal phalanx of one of the digits. The device 200 can be adapted to wirelessly transmit and receive data using, for example, Bluetooth or any other suitable radio-frequency communications protocol such as ZigBee for example; infrared or fast infra-red; or other suitable communications means such as in-audible (to humans) sound such as ultrasound for example, or other invisible (to humans) light.

According to one embodiment, device 100 is worn by/fixed to a user on a portion of a digit of one hand with device 200 worn/fixed on a portion of a digit of the other hand. The devices 100,200 can be wirelessly coupled using one of the afore-mentioned wireless communications protocols. At least one of the devices 100,200 is operable to transmit and receive data, with the other of the devices operable to transmit data at least. It will be appreciated that the provision of wireless communications functionality of the devices is advantageous, but not essential, and the devices 100,200 can be physically connected together using wire for example, or other suitable connectors such as fiber optic cables or the like.

Device 200 can be passive. More specifically, the device can be adapted to draw power from device 100 using electromagnetic coupling such as inductive coupling for example. This is advantageous as it obviates the requirement for a power supply in device 200. Device 100 can include a suitable power source such as a battery for example, which is suitable for powering device 100 directly and device 200 indirectly (inductively).

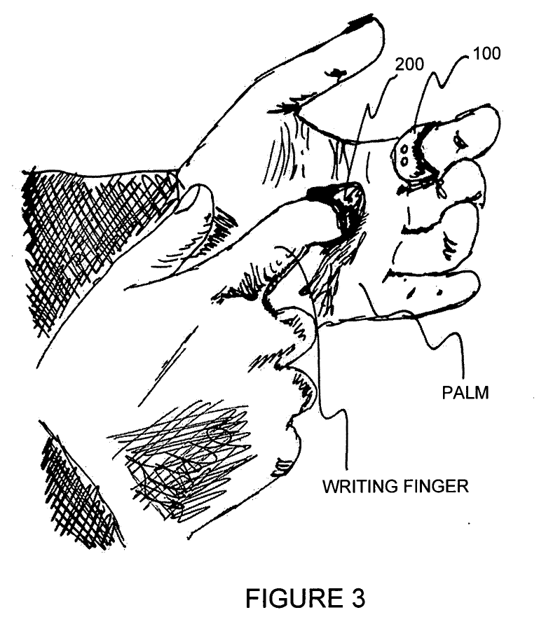

FIG. 3 is a schematic representation of an arrangement of the devices 100,200 of FIGS. 1 and 2 according to one use model. In FIG. 3, a user (not shown) wears device 100 on a digit of their left hand as shown, and device 200 on a digit of their right hand as shown. Alternative configurations are possible. Also, it will be appreciated that each of the devices 100,200 are suitable for left or right handed use.

Device 200 is operable to generate and transmit data to device 100 relating to movement of the device 200. The data is transmitted using one of the aforementioned communications methods. Upon reception of the data, device 100 is operable to either directly transmit it wirelessly to a remote device such as a computer, PDA, mobile telephone and the like, or process the data using a suitable processor (not shown) and transmit it to a remote device. Alternatively, data may be processed in a suitable processor of device 200 (not shown) before transmission to device 100. Device 100 can be adapted to receive data from the remote device.

In an alternative embodiment, the device 200 may transmit data (directly or after having been processed using a suitable processor of the device) to a remote device, thereby by-passing transmission of data to device 100.

In one embodiment, data transmitted by device 200 to device 100 relates to a change in position/movement of the device 200 relative to the device 100. In this connection, devices 100,200 are operable to communicate with one another in order that a location of the device 200 with respect to device 100 is available whilst the devices are in range of one another. The generation of suitable data will be described below in more detail.

The range of the devices will be determined by the communication method used by the devices, and practical considerations. For example, although a Bluetooth communication channel between the devices will be operable up to a range of approximately 10 m, this is not practical. A suitable range of the devices within which communication is enabled and effective may be determined on a case by case basis taking into account the physical characteristics of the user such as a comfortable positioning of the hands for example.

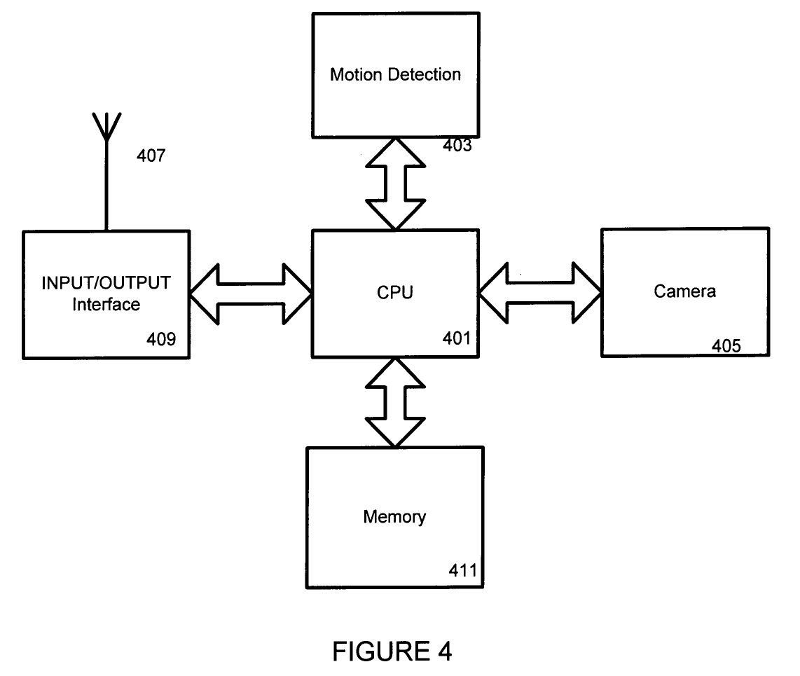

FIG. 4 is a schematic block diagram of a suitable architecture for the device 200. A processor 401 of device 200 can be an application specific integrated circuit (ASIC) or other suitable processing unit operable to receive and process data received from either of a movement detector 403 or camera 405 of the device 200. The movement detector 403 and camera 405 are optional and device 200 can include one or both of these components.

The movement detector 403 is operable to sense changes in the position of the device 200 and generate movement data representing such changes. Detector 403 may be an accelerometer for example, or other similar device. The movement data can be processed by the processor 401, and transmitted from the device 200 using a suitable antenna 407 using the input/output interface 409. Processing of the data prior to transmission can include determining a relative position of the device 200 with respect to the device 100. This can be affected using a comparison between data received from the device 100 representing its position, and the movement data representing a change in position of device 200, in order to provide data representing a relative position of the device 200 with respect to the device 100. This ‘disposition’ data can be transmitted to the device 100, or an external device such as a computer, PDA, or mobile station (such as a mobile telephone for example). Alternatively, ‘raw’ movement data (i.e. substantially unprocessed by processor 401) generated by device 200 may be transmitted to the device 100 which then transmits it to an external source, or the raw movement data generated by device 200 can be transmitted directly to an external device such as a computer, PDA, or mobile station (such as a mobile telephone for example).

Memory 411 of the device 200 can comprise RAM, ROM or WOM (write-only memory) or a combination thereof. In the case that the memory 411 comprises WOM, the memory is operable, in one embodiment, to be queried only by the device 100 using suitable commands sent to the processor 401 by the device 100 using the antenna 409.

Camera 405 can replace the movement detector 403, in which case the camera 405 is operable to generate data relating to an image of a portion of a users hand, and more specifically data representing an image of a portion of a users hand on which device 100 is worn. The generated data can be compared with pre-stored data representing an image of the users hand in order to determine a measure of the position of the device 200 with respect to the user's hand and therefore indirectly with respect to device 100.

Pre-stored image data may be stored in memory 411, a suitable memory of the device 100 (not shown), or alternatively suitable storage of a remote computer, PDA or mobile station (such as a mobile telephone for example). Determination of the position of the device 200 with respect to device 100 using the movement data and the pre-stored data may be effected in the device 100, 200 or remotely in an external device. Transmission and reception of the data required to effect the determination is effected using the antenna 409 of device 200, or a suitable antenna of the device 100 or of the external device (not shown) as required.

The architecture of the device 100 is similar to that of device 200 depicted in FIG. 4. The device 100 exemplary does not include a camera or motion detection unit, but can optionally include other units as will be described below in more detail.

Alternatively to that described above, and according to another embodiment, the relative position of the device 200 with respect to device 100 may be determined using an infra-red beam emitted from device 100.

In this connection, device 100 can comprise suitable functionality for emitting the infrared beam across the palm of the hand, or other suitable area, on which the device 100 is being worn or is otherwise mounted/supported. This functionality can comprise an infra-red emitter in the device 100 and a corresponding infra-red receiver for receiving any reflected/scattered infra-red.

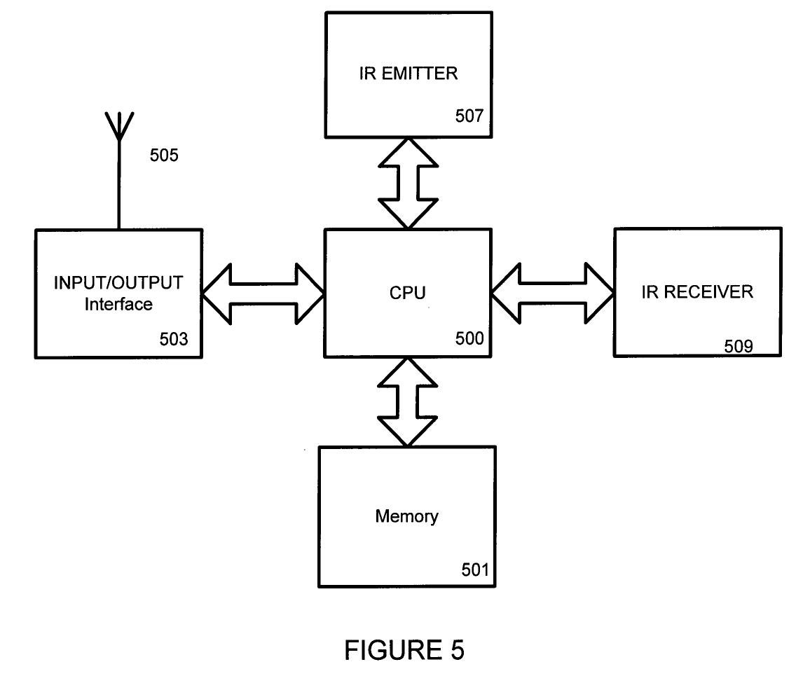

In this connection, FIG. 5 shows a suitable architecture for the device 100. The device 100 comprises the same basic functional components as the device 200 (processing unit 500, memory 501, input/output interface 503 and suitable antenna 505). In addition, device 100 includes an infra-red emitter 507 and receiver 509 suitable for emitting infra-red. It will be appreciated that the emitter 507 and receiver 509 may be incorporated in the same device element, but are shown separately for the sake of clarity.

The emitted beam can be generated using an infra-red emitter and suitable known beam scattering apparatus as is known. The scattered beam is adapted to provide an effective ‘sheet’ of infra-red covering the palm of a user's hand. The generation of this sheet may be effected using an infra-red beam incident on a rapidly oscillating piezo-electric element adapted to reflect the beam in the manner required for example. Other alternatives are possible. In one embodiment, the scanning of the beam is effected sufficiently quickly such that substantially the entire palm is swept by the beam in a time which enables any change in position of the device 200 to be sensed.

A change in the position of the device 200 with respect to device 100 can be determined in a number of ways. For example, the receiver 509 of device 100 can be adapted to receive infra-red which has been scattered as a result of the device 200 moving through the beam at a particular time. Changes in position are determined using the time taken for a scattered beam to reach the receiver, and the direction of the beam at the instant scattering occurred. The direction of the beam can be determined as a function of the current applied to a piezo-electric element for example.

Alternatively, the device 200 may include an infra-red receiver (in which case device 100 need not require receiver 509). In order to generate position data, the devices 100,200 are synchronized in this arrangement in order that device 200 transmits data to device 100 (or directly to an external device as required) whenever a beam is incident on the receiver of device 200. The device 100 is operable to determine the position of the beam when it was intercepted by device 200 from this data and therefore determine a position of the device 200 with respect to device 100 using this and using data relating to the time taken from transmission of the beam at the relevant position, to reception of the beam at a receiver of 100.

In addition to any of the above, device 100 can be operable to generate data relating to a measure of electrical conductivity representative of whenever device 200 is incident on the hand for example of the user upon which device 100 is supported or mounted. So, for example, device 100 can generate data representing a tap or taps of device 200 against a user's hand. Since the electrical conductivity will generally increase with an increase in the pressure of application of device 200 against the skin, the data can also provide a measure of the pressure with which the device 200 is incident upon the user's hand. Such data may be processed by a suitable processor of the device 100, and can be transmitted to a remote device similarly to above.

In order to effect the generation of electrical conductivity data, the device 100 can monitor the strength of electrical current received from the device 200 through the skin of a user. For example, device 200, powered by its own power source, or powered inductively from device 100, can generate a small electrical current which can be detected using the natural ability of the skin to conduct electricity by the device 100. As mentioned, the strength of the detected current can provide a measure of the pressure with which the device 200 was incident upon the user's hand. Such data may be represented in a discrete fashion, such as using a value between 0 and 255 for example, with 0 representing substantially no pressure, and 255 representing a maximum detectible pressure for example. Other alternatives are possible.

Device 200 can optionally include functionality such as an accelerometer and/or pathfinder-type device in order to increase the accuracy of any generated movement data.

Generated movement data can be compared to data stored in a memory of an input device or a remote device. Such stored data can represent at least one hidden Markov model for example, the or each model representative of respective movements of a device or of the devices. Generated movement data can be compared to the stored data in order to determine and select a model with the highest probability of representing the motion of the device or devices which has caused the generation of the movement data. Input data can then be generated on the basis of the selected model, the input data representative of data to be input to a remote device, or relating to data suitable for effecting execution of a function of the remote device.

It should be noted that where reference has been made above to “antenna” or “suitable antenna” such a device can be substituted by a suitable emitter/receiver of infra-red radiation or ultrasound and so forth.

Further, where reference has been made to a user and to arrangements of devices which are cooperatively operable to affect exemplary embodiments, these references and configurations are not intended to be limiting, and are included herein by way of example only. Other configurations are envisaged.

Therefore, having thus described the invention, at least the following is claimed:

1. Machine-human interface apparatus comprising:
a first device adapted to be substantially fixedly mounted relative to a portion of a first hand of a user; and
a second device adapted to be substantially fixedly mounted relative to a portion of a digit of the other hand of the user, at least one of the devices comprising a transducer operable to generate a signal representative of the relative position or movement of the devices.

2. Apparatus as claimed in claim 1, wherein the first input device is adapted to be substantially fixedly mounted relative to a portion of a digit of the first hand of a user.

3. Apparatus as claimed in claim 1, wherein the first input device further comprises an infra-red emitter operable to generate an infra-red beam for emission over a portion of the palm of the first hand of the user.

4. Apparatus as claimed in claim 1, wherein the transducer is operable to generate any one of either a short-range radio frequency signal, an infra-red signal, or an ultrasound signal.

5. Apparatus as claimed in claim 1, wherein the first and second devices are inductively coupled.

6. Apparatus as claimed in claim 1, wherein the signal is used to control an input function of an external device.

7. Apparatus for inputting data to a remote device comprising first and second wirelessly coupled input devices, the first device adapted to be substantially fixedly supported relative to a first hand of a user, the second device adapted to be substantially fixedly supported relative to a portion of a digit of the other hand of a user, wherein at least one of the devices comprises a sensor operable to generate a signal representing a relative position of the devices.

8. An apparatus as claimed in claim 7, wherein the devices are wirelessly coupled using any one a short-range radio frequency protocol connection, infra-red, fast infra-red, or ultrasound wireless connection.

9. An apparatus as claimed claim 7, wherein the first and second devices are inductively coupled such that either of the first or second input devices is operable to inductively draw power from the other input device.

10. An apparatus as claimed in claim 7, wherein each device is wirelessly coupled to the remote device.

11. An apparatus as claimed in claim 10, wherein the remote device is any of a computer, PDA, mobile telephone, pager, or any hybrid device of the above operable to use the signal for input purposes.

12. An apparatus as claimed in claim 7, wherein the first device is adapted to be worn on the proximal phalanx of a finger of the first hand of the user, and the second device is adapted to be worn on the distal phalanx of a finger of the other hand of the user.

13. An apparatus as claimed in claim 7, wherein the second device includes a motion detector adapted to generate motion data representative of a movement of the second device.

14. An apparatus as claimed in claim 7, wherein the second device includes an image capture device adapted to generate image data representing an image captured from a standpoint of the second device.

15. An apparatus as claimed in claim 14, wherein the image data represents an image of at least a portion of the palm of the first hand of a user of the apparatus.

16. An apparatus as claimed in claim 14, wherein the image data is used to generate position data representing a position of the second device with respect to the palm of the first hand of a user, the position data used to generate data representing the position of the first device with respect to the second device.

17. An apparatus as claimed in claim 13, wherein the motion data is transmitted from the second device to the first device using the wireless connection.

18. An apparatus as claimed in claim 17, wherein the first device further comprises a processor adapted to determine a relative position of the second device to the first device on the basis of the received motion data.

19. A device suitable for being substantially fixedly supported relative to a portion of a hand of a user, the device suitable for use in accordance with the apparatus as claimed in claim 7.

20. A method of inputting data to a remote device using two input devices, each device substantially fixedly supported relative to a portion of a respective hand of a user, the method comprising:
generating movement data in at least one of the devices representing a position or movement of one device with respect to the other device;
comparing the generated movement data with stored data representative of relative movements of the devices, the stored data corresponding to respective characters to be input to the remote device, or of respective functions for controlling the remote device; and
inputting data to the remote device on the basis of the comparison of the generated data to the stored data.

21. A method as claimed in claim 20, wherein the data input to the remote device is either data representing a character to be input to the remote device, or is data relating to a function of the remote device, the input data thereby causing the remote device to execute or otherwise prepare for execution of the said function of the device.

22. A method as claimed in claim 20, wherein the stored data is in the form a at least one hidden Markov model, and comparing the generated movement data comprises selecting a model with the highest probability of representing a movement of the devices, and generating data representing data for input on the basis of the selected model.

23. A method as claimed in claim 20, wherein the remote device is any of a computer, PDA, mobile telephone, pager, or any hybrid device of the above, wherein inputting data to the device is effected using a wireless communications protocol.
